(19) United States
(12) Patent Application Publication
(10) Pub. No.: US 2025/0316888 A1
(43) Pub. Date: Oct. 9, 2025

(54) FEEDING APPARATUS, ANTENNA, BASE STATION, AND COMMUNICATION SYSTEM

(71) Applicant: HUAWEI TECHNOLOGIES CO., LTD., Shenzhen (CN)

(72) Inventors: Xinming Liu, Xi'an (CN); Peifeng Hu, Xi'an (CN); Jiaxu Li, Xi'an (CN); Weihong Xiao, Dongguan (CN); Jinsong Lv, Shanghai (CN)

(73) Assignee: HUAWEI TECHNOLOGIES CO., LTD., Shenzhen (CN)

(21) Appl. No.: 19/243,284

(22) Filed: Jun. 19, 2025

Related U.S. Application Data
(63) Continuation of application No. PCT/CN2023/133356, filed on Nov. 22, 2023.

(30) Foreign Application Priority Data
Dec. 22, 2022 (CN) 202211655411.5

(51) Int. Cl. H01Q 1/24; H01Q 3/36

(52) U.S. Cl. CPC H01Q 1/246; H01Q 3/36

(57) ABSTRACT

A feeding apparatus, an antenna, a base station, and a communication system are provided. The feeding apparatus includes a plurality of functional modules. Each functional module is configured to process a radio frequency signal. The plurality of functional modules are stacked in a same direction or stacked in different directions. According to the feeding apparatus provided in this application, the plurality of functional modules are stacked, to fully utilize three-dimensional space, implement a three-dimensional feeding apparatus, and reduce space occupied by the feeding apparatus.

### CROSS-REFERENCE TO RELATED APPLICATIONS

This application is a continuation of International Application No. PCT/CN2023/133356, filed on Nov. 22, 2023, which claims priority to Chinese Patent Application No. 202211655411.5, filed on Dec. 22, 2022. The disclosures of the aforementioned applications are hereby incorporated by reference in their entireties.

### TECHNICAL FIELD

This application relates to the field of wireless communication technologies, and in particular, to a feeding apparatus, an antenna, a base station, and a communication system.

### BACKGROUND

A feeding apparatus may also be referred to as a feeding network, and is an important component of a remote electrical tilt antenna, for example, a phase shifter. Performance of the feeding apparatus directly affects performance of a base station antenna. With improvement of integration of the base station antenna, higher requirements are imposed on the feeding apparatus in terms of a dimension, weight, performance, and the like. As an important component inside the base station antenna, a size of the phase shifter directly affects an overall size and layout of the base station antenna. With an increasing quantity of antenna integration ports, a conventional phase shifter occupies large space. This does not facilitate an overall layout. In addition, in some scenarios, for an electromagnetic stealth antenna, a small cross-sectional area requirement is also imposed on the phase shifter.

### SUMMARY

To overcome the foregoing problem, embodiments of this application provide a feeding apparatus, an antenna, a base station, and a communication system. A plurality of functional modules are stacked, to fully utilize three-dimensional space, implement a three-dimensional feeding apparatus, and reduce space occupied by the feeding apparatus.

This application provides a feeding apparatus, including a plurality of functional modules. Each functional module is configured to process a radio frequency signal. The plurality of functional modules are stacked in a same direction or stacked in different directions. The functional modules in the feeding apparatus are stacked instead of being distributed in an extension manner in one direction, to fully utilize three-dimensional space, and implement miniaturization of the feeding apparatus.

The functional module may be one or more of a phase shifter, a power divider, a combiner, a filter, or the like. For example, the feeding apparatus includes a plurality of power dividers, to implement power allocation for a radio frequency signal. The plurality of power dividers are stacked in one direction or stacked in different directions, to reduce space occupied by the feeding apparatus in one direction, and implement a three-dimensional feeding apparatus.

In a possible implementation, the plurality of functional modules include at least N phase shift modules, M power division modules, and a transfer module. N is a positive integer greater than or equal to 2, and M is a positive integer greater than or equal to 1. Each phase shift module is configured to perform phase shift processing on an input radio frequency signal. Each power division module is configured to perform power distribution processing on the input radio frequency signal. The transfer module is configured to electrically connect the phase shift module and the power division module, to form a feeding circuit. The N phase shift modules and the M power division modules are stacked in a same direction or stacked in different directions.

According to the feeding apparatus provided in this application, a plurality of phase shift modules and power division modules are stacked, to fully utilize three-dimensional space, implement a three-dimensional phase shift feeding apparatus, and reduce space occupied by the feeding apparatus.

In a possible implementation, the N phase shift modules and the M power division modules are alternately stacked in a same direction.

In another possible implementation, the transfer module includes a first transfer submodule and a second transfer submodule, and the first transfer submodule and the second transfer submodule are respectively disposed at two opposite ends of a first stacked structure formed by the N phase shift modules and the M power division modules.

The transfer module is located at the two opposite ends of the first stacked structure, so that a stacking thickness of the first stacked structure is not increased. Instead, space in a stacking direction is facilitated, and a cross-sectional area of the phase shift feeding apparatus is reduced.

In addition, the transfer module facilitates centralized distribution, for ease of integration.

In another possible implementation, the N phase shift modules are stacked to form a second stacked structure, and outer wall surfaces of the M power division modules in an extension direction are in contact with end parts of the second stacked structure. To be specific, the N phase shift modules and the M power division modules are stacked in different directions, and the M power division modules are not further stacked in a stacking direction of the N phase shift modules, so that a thickness of the second stacked structure is not increased. Instead, the M power division modules are disposed at the end parts of the second stacked structure, to facilitate thickness space of the second stacked structure, and reduce a cross-sectional area of the phase shift feeding apparatus.

In another possible implementation, the N phase shift modules and the M power division modules are stacked in a same direction to form a third stacked structure, and the M power division modules are stacked adjacently.

In another possible implementation, the M power division modules are located at an inner layer of the third stacked structure, and the N phase shift modules are located at an outer layer of the third stacked structure.

In another possible implementation, the feeding apparatus further includes a phase compensation module. The phase compensation module and the transfer module are respectively disposed at two opposite ends of the third stacked structure.

The N phase shift modules and the M power division modules are stacked in a same direction, and other functional modules are disposed in a direction perpendicular to the N phase shift modules and the M power division modules, to form a three-dimensional phase shift feeding apparatus, and reduce space occupied by the feeding apparatus.

In another possible implementation, the feeding apparatus further includes a plurality of output interfaces. Each output interface is configured to output a radio frequency signal processed by the phase shift feeding apparatus. The plurality of output interfaces are disposed on a same plane or disposed on different planes.

In another possible implementation, each functional module has a circuit structure and a cavity, and the circuit structure is accommodated in the cavity. For example, the plurality of functional modules include a phase shift module, a power division module, and a transfer module. The phase shift module, the power division module, and the transfer module each have a cavity. A phase shift circuit corresponding to the phase shift module, a power division circuit corresponding to the power division module, and a transfer circuit corresponding to the transfer module are all disposed in respective cavities. In other words, a circuit structure form of each functional module is a strip line form.

In another possible implementation, the feeding apparatus provided in this embodiment of this application includes a frame structure. The frame structure is configured to support and position the plurality of functional modules, so that the plurality of functional modules form a structure stacked in a same direction or stacked in different directions. For example, an implementation form of a circuit structure of each functional module is a microstrip structure (for example, a PCB circuit board). A plurality of PCB circuit boards corresponding to the plurality of functional modules are supported and positioned through the frame structure, to form a more three-dimensional structure stacked in a same direction or stacked in different directions.

Each functional submodule of the feeding apparatus, for example, each of the phase shift module, the power division module, and the transfer module, has an independent environment, to ensure that the entire apparatus is slightly affected by coupling. In addition, during assembly, the functional submodules are independently affected by structural tolerances, so that a tolerance of an electrical sensitive network can be improved in a targeted manner, to improve electrical consistency.

In another possible implementation, the phase shift module, the power division module, and the transfer module are detachably connected. When one of the functional modules is faulty, it is easy to replace the faulty module.

In another possible implementation, the feeding apparatus is integrally formed. For example, the phase shift feeding apparatus is printed by using a 3D printing technology. This avoids an assembly process, and improves integrity of the feeding apparatus.

According to a second aspect, an embodiment of this application further provides an antenna, including the feeding apparatus according to the first aspect and a plurality of radiating elements. The feeding apparatus feeds a processed radio frequency signal into the plurality of radiating elements, so that the plurality of radiating elements radiate electromagnetic beams outward.

According to a third aspect, an embodiment of this application further provides a base station, including the antenna according to the second aspect.

According to a fourth aspect, an embodiment of this application further provides a communication system, including the base station according to the third aspect.

### BRIEF DESCRIPTION OF DRAWINGS

The following briefly describes accompanying drawings that need to be used in description of embodiments.

FIG. 1 is a diagram of a structure of a phase shift feeding apparatus according to an embodiment of this application;

FIG. 2 is a diagram of a structure of another phase shift feeding apparatus according to an embodiment of this application;

FIG. 3 is a diagram of a structure of another phase shift feeding apparatus according to an embodiment of this application; and

FIG. 4 is a diagram of a structure of another phase shift feeding apparatus according to an embodiment of this application.

### DESCRIPTION OF EMBODIMENTS

The following describes the technical solutions in embodiments of this application with reference to the accompanying drawings in embodiments of this application.

In description of this application, orientation or position relationships indicated by the terms “center”, “upper”, “lower”, “front”, “rear”, “left”, “right”, “vertical”, “horizontal”, “top”, “bottom”, “inner”, “outer”, and the like are orientation or position relationships shown based on the accompanying drawings, and are merely intended for ease of describing this application and simplifying descriptions, instead of indicating or implying that a specified apparatus or component needs to have a specific orientation or be constructed and operated in a specific orientation. Therefore, this cannot be understood as a limitation on this application.

In description of this application, it should be noted that, unless otherwise clearly specified and limited, terms “mount”, “link”, and “connect” should be understood in a broad sense, for example, may be a fixed connection, may be a detachable connection, or may be an abutting connection or an integral connection. Persons of ordinary skill in the art may understand specific meanings of the foregoing terms in this application based on specific cases.

A feeding apparatus provided in embodiments of this application mainly resolves an overall layout problem caused by an excessively large size of a feeding network. The feeding apparatus is divided into several functional submodules. The functional submodules are units independent of each other. The functional submodules are not on a same plane, and may be stacked in a same direction or may be stacked in different directions, to ensure that at least two subnetworks are on a same projection plane, and implement a three-dimensional feeding apparatus. Further, the subunits are connected through a transfer module, to fully utilize three-dimensional space, and implement miniaturization of the phase shifter.

For example, the functional module may be one or more of a phase shifter, a power divider, a combiner, a filter, or the like. For example, the feeding apparatus includes a plurality of power dividers, to implement power allocation for a radio frequency signal. The plurality of power dividers are stacked in one direction or stacked in different directions, to reduce space occupied by the feeding apparatus in one direction, and implement a three-dimensional feeding apparatus.

It should be noted that, the feeding apparatus may also have other names, for example, a feeding network, a phase shift power division network, and a phase shift power division apparatus, and even some persons skilled in the art are accustomed to referring to the feeding apparatus as a phase shift network or a phase shifter. The phase shift module may also be referred to as a phase shift unit, a phase shift network, a phase shift part, a phase shift component, or the like. The power division module may also be referred to as a power division unit, a power division network, a power division part, a power division component, or the like. The transfer module may also be referred to as a transfer network, a transfer unit, or the like.

The following uses an example in which the feeding apparatus is a phase shift feeding apparatus to describe in detail a specific structure of the feeding apparatus provided in embodiments of this application.

To facilitate understanding of a feeding apparatus, an antenna, a base station, and a communication system provided in embodiments of this application, the following describes in detail the feeding apparatus, the antenna, the base station, and the communication system with reference to specific embodiments and the accompanying drawings.

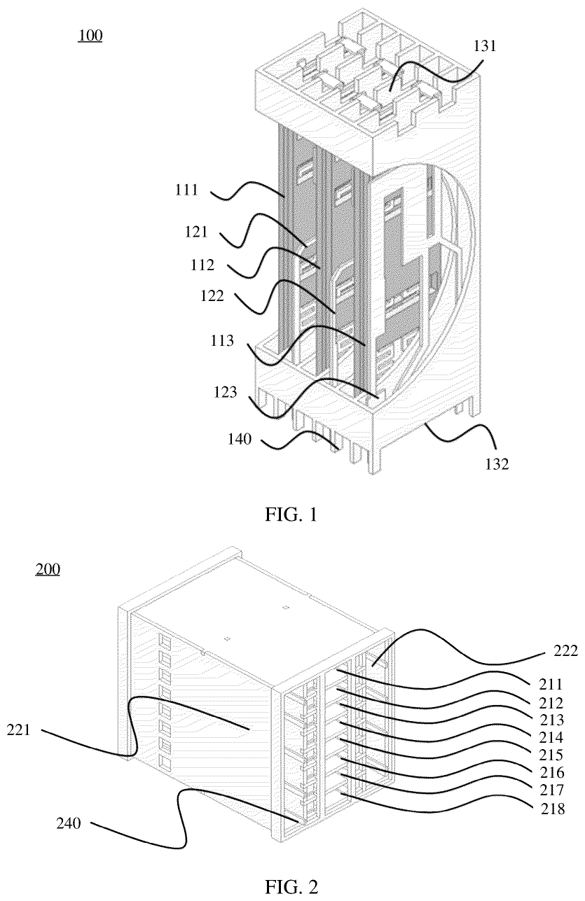

FIG. 1 is a diagram of a structure of a phase shift feeding apparatus according to an embodiment of this application. FIG. 1 shows a phase shift feeding apparatus 100 in a 1-to-7 series feeding form. As shown in FIG. 1, the phase shift feeding apparatus 100 includes a plurality of phase shift feeding modules, for example, a phase shift module 111, a phase shift module 112, and a phase shift module 113 in FIG. 1, a plurality of power division modules, for example, a power division module 121, a power division module 122, and a power division module 123 in FIG. 1, and transfer modules, for example, a transfer module 131 and a transfer module 132 in FIG. 1. The phase shift module is configured to perform phase shift processing on an input radio frequency signal. The power division module is configured to perform power distribution processing on the input radio frequency signal. The transfer module is configured to electrically connect the phase shift module and the power division module in a preset connection manner. For example, in FIG. 1, the transfer module electrically connects the power division module and the phase shift module that are located at different layers, to form a feeding circuit. Specifically, the feeding circuit is a series feeding circuit.

Certainly, the feeding circuit formed by electrically connecting, by the transfer module, the power division module and the phase shift module that are located at different layers may alternatively be a parallel feeding circuit or a series-parallel hybrid feeding circuit.

Optionally, an electrical connection manner of the transfer module may be welding, coupled feeding, or the like. The electrical connection manner of the transfer module is not specifically limited in this embodiment of this application, and an appropriate electrical connection manner may be selected based on a requirement.

The plurality of phase shift modules and the plurality of power division modules may be stacked in a same direction. For example, the plurality of phase shift modules and the plurality of power division modules are stacked in a same direction in an alternate stacking manner, for example, in FIG. 1, are stacked in a sequence of the phase shift module 111, the power division module 121, the phase shift module 112, the power division module 122, the phase shift module 113, and the power division module 123, to form a stacked structure.

The transfer module 131 and the transfer module 132 are respectively disposed at two opposite ends of the stacked structure formed by the plurality of phase shift modules and the plurality of power division modules.

For example, as shown in FIG. 1, both the phase shift module and the power division module are of rectangular plate structures. A stacked structure is formed after the plurality of phase shift modules and power division modules are stacked in a same direction. The stacked structure is a cuboid structure. The transfer module 131 and the transfer module 132 are respectively disposed at two opposite ends of the stacked structure in a length direction.

In an example, to further implement miniaturization of the phase shift feeding apparatus, the phase shift module and the power division module have a same shape and size. A regular cuboid structure is formed after the plurality of phase shift modules and power division modules are alternately stacked. An extension surface of the transfer module is adapted to a shape of an end part of the stacked structure. For example, a shape of a cross section of the transfer module and a shape of a cross section of the stacked structure are the same and are both rectangular. In this way, after the transfer modules are disposed at two opposite ends of the stacked structure, the extension surface of the transfer module is laminated to an end surface of the stacked structure, and the transfer module does not occupy space other than space covered by the cross section of the stacked structure, so that space occupied by the phase shift feeding apparatus is not excessively increased after the transfer module is disposed.

Certainly, an extension surface of the transfer module may alternatively be less than a shape of an end part of the stacked structure, or an extension surface of the transfer module is greater than an end surface of the stacked structure, to facilitate connection of the transfer module. A size of the extension surface of the transfer module is not specifically limited herein, and an appropriate size may be selected based on a requirement.

To further reduce space occupied by the phase shift feeding apparatus, the plurality of phase shift modules and the plurality of power division modules are laminated, to reduce space occupied, in a stacking direction, by a stacked structure formed after the plurality of phase shift modules and the plurality of power division modules are stacked. For example, the phase shift module includes a housing and a phase shift circuit structure, the housing includes an accommodating cavity, and the phase shift circuit structure is accommodated in the accommodating cavity. The power division module includes a housing and a power division circuit structure, the housing includes an accommodating cavity, and the power division module structure is accommodated in the accommodating cavity. That the plurality of phase shift modules and the plurality of power division modules are laminated means that an outer wall surface of the housing of the phase shift module and an outer wall surface of the power division module are closely laminated.

The phase shift circuit structure and the power division circuit structure may be in a plurality of circuit forms, for example, strip line structures or microstrip structures.

Still referring to FIG. 1, the phase shift feeding apparatus 100 further includes a plurality of output interfaces 140. The transfer module 132 leads, to the output interfaces, output lines of a plurality of feeding circuits formed by the plurality of phase shift modules and power division modules. A quantity of the plurality of output interfaces 140 is the same as a quantity of the feeding circuits. The plurality of output interfaces 140 are connected to a plurality of radiating elements of an antenna array. Each output interface 140 feeds, into a radiating element connected to the output interface 140, a radio frequency signal processed by a corresponding feeding circuit, so that the radiating element radiates an electromagnetic beam outward.

Optionally, the plurality of output interfaces 140 may be disposed on a same plane. For example, in FIG. 1, the plurality of output interfaces 140 are all disposed on an end surface of the stacked structure formed by stacking the plurality of phase shift modules and power division modules. In another example, the plurality of output interfaces 140 are disposed on different planes. For example, the plurality of output interfaces 140 are distributed on different side surfaces or end surfaces of the stacked structure.

It should be explained that, an implementation type of the phase shift module is not specifically limited in this embodiment of this application. For example, the phase shift module may be of a physical phase shift type, or may be of a dielectric phase shift type. A strip form of the phase shift module may be a microstrip, a strip line, or the like. An appropriate implementation type of the phase shift module may be selected based on an actual requirement.

Persons skilled in the art easily understand that the phase shift module is a device capable of adjusting a phase of a radio frequency signal. The phase shift module is widely used in fields such as radar, missile attitude control, accelerators, communication, instruments, and even music. The phase shift module may be connected between an antenna array and a radio frequency channel, and is configured to adjust a phase of a received radio frequency signal based on a target beam.

It should be noted that, a target direction of a target beam formed by an antenna is adjusted by adjusting a phase of a radio frequency signal. The target direction may determine a target phase. Therefore, the phase shift module may be adjusted to the target phase, a beam direction may be determined based on the target direction, and a needed target phase may be determined based on the direction.

The power division module is a device that divides energy of one input signal into two or more outputs of equal or unequal energy, and conversely, may also combine energy of a plurality of signals into one output. Power division modules are usually classified into one-to-two (one input and two outputs), one-to-three (one input and three outputs), and the like based on outputs.

When receiving a radio frequency signal, the power division module may perform power allocation for a plurality of columns of antennas, so that the antenna array forms a needed beam when receiving the radio frequency signal, without a need to reduce power of the radio frequency signal, thereby ensuring highest power utilization. It should be noted that, if an antenna has only one radiating element, the power division module is not needed.

In an example, the plurality of phase shift modules, the plurality of power division modules, the transfer modules, and the output interfaces are detachably connected, in other words, the plurality of phase shift modules, the plurality of power division modules, the transfer modules, and the output interfaces are assembled to form a complete phase shift feeding apparatus.

For example, the plurality of phase shift modules, the plurality of power division modules, the transfer modules, and the output interfaces each have a housing and a corresponding circuit structure. The housing has an accommodating cavity, and the circuit structure is accommodated in the accommodating cavity. Assembly structures are disposed on housings of the phase shift module, the power division module, the transfer module, and the output interface. For example, the phase shift module, the power division module, the transfer module, and the output interface are connected through insertion or clamping. Insertion parts are disposed at end parts of housings of the phase shift module and the power division module, and insertion slots are disposed on a housing of the transfer module. The insertion parts are fitted with the insertion slots, to fasten the phase shift module and the power division module to the transfer module through insertion. A clamping part is disposed on a housing of the output interface, and a clamping interface adapted to the clamping part is disposed on a wall surface that is of the housing of the transfer module and that corresponds to the output interface. The clamping part is fitted with the clamping interface, to fasten the output interface to the transfer module through clamping.

The foregoing specific connection manner of the detachable connection is merely an implementable example, and does not constitute a limitation on a connection manner of the detachable connection of the phase shift feeding apparatus provided in this embodiment of this application. The phase shift module, the power division module, the transfer module, and the output interface may alternatively be connected in another detachable connection manner, for example, connected through connecting pieces. An appropriate connection manner may be selected for connection based on an actual case.

The functional modules of the phase shift feeding apparatus are detachably connected, so that the modules are independent, and only a faulty module may be replaced, to reduce maintenance costs.

In another example, a line implementation form of each of the plurality of phase shift modules, the plurality of power division modules, and the transfer modules is a microstrip form, for example, a PCB board. The phase shift feeding apparatus provided in this embodiment of this application further includes a frame structure. A plurality of PCB circuit boards corresponding to the plurality of phase shift modules, the plurality of power division modules, and the transfer modules are supported and positioned through the frame structure, to form a more three-dimensional structure stacked in a same direction or stacked in different directions.

Certainly, in some other examples, the phase shift feeding apparatus may alternatively be in an integral connection. For example, the phase shift module, the power division module, the transfer module, and the output interface are connected in an integral connection manner such as gluing or welding, so that the phase shift feeding apparatus is in a more secure and reliable connection. Alternatively, the phase shift feeding apparatus may be integrally formed. For example, the phase shift feeding apparatus may be integrally printed by using a 3D printing technology, to improve integrity of the phase shift feeding apparatus.

According to the phase shift feeding apparatus provided in this embodiment of this application, functional networks in the feeding apparatus are modularized to form a plurality of functional subnetworks (for example, a phase shift module, a power division module, a transfer module, and an output interface). The modules are stacked in a three-dimensional manner, to fully utilize three-dimensional space, and implement miniaturization of the phase shift feeding apparatus. The modular subnetworks help normalize functional submodules, to form standard modules with unified interfaces, to be used in another feeding network. In addition, a size of the subnetwork obtained after division is small enough, so that a precision machining process that cannot be previously applied due to a size problem can be introduced. Furthermore, each of the functional submodules obtained by dividing the phase shift feeding apparatus has an independent environment, to ensure that the entire apparatus is slightly affected by coupling. In addition, during assembly, the functional submodules are independently affected by structural tolerances, so that a tolerance of an electrical sensitive network can be improved in a targeted manner, to improve electrical consistency.

In some other embodiments, the functional modules of the phase shift feeding apparatus may alternatively be distributed in another manner.

FIG. 2 is a diagram of a structure of another phase shift feeding apparatus according to an embodiment of this application. FIG. 2 shows a phase shift feeding apparatus 200 in a 1-to-8 parallel feeding form. As shown in FIG. 2, a plurality of phase shift modules are stacked in one direction to form a stacked structure. For example, as shown in FIG. 2, a phase shift module 211, a phase shift module 212, a phase shift module 213, a phase shift module 214, a phase shift module 215, a phase shift module 216, a phase shift module 217, and a phase shift module 218 are stacked to form a stacked structure. A power division module 221 and a power division module 222 are respectively disposed at end parts of the stacked structure formed by the plurality of phase shift modules. For example, the power division module 221 and the power division module 222 are respectively disposed at two opposite ends of the stacked structure, and the two opposite ends are two opposite ends of the stacked structure in a width direction.

The power division module 221 and the power division module 222 each are of a plate structure. A plate surface of the plate structure is in contact with an end part of the stacked structure. To minimize space occupied by the phase shift feeding apparatus, a shape and a size of the plate surface of the plate structure are adapted to the end part of the stacked structure, so that the phase shift feeding apparatus is still a regular cuboid structure after the power division module 221 and the power division module 222 are disposed. In other words, the power division module 221 and the power division module 222 are respectively disposed at two side ends of the stacked structure formed by the plurality of phase shift modules. Cables are led out from two sides of the plurality of phase shift modules, and are respectively electrically connected to the power division module 221 and the power division module 222, to form a 1-to-8 feeding circuit.

Certainly, in some other examples, alternatively, the power division module 221 and the power division module 222 may be respectively disposed at two opposite ends of the stacked structure in a length direction, or the power division module 221 and the power division module 222 may be respectively disposed at two adjacent ends of the stacked structure. This is not specifically limited in this application.

In some other examples, there may alternatively be one power division module. For example, the power division module may be a one-to-nine power divider. The power divider divides an input radio frequency signal into nine radio frequency sub signals. The phase shift module 211, the phase shift module 212, the phase shift module 213, the phase shift module 214, the phase shift module 215, the phase shift module 216, the phase shift module 217, and the phase shift module 218 are respectively disposed on eight branches to perform phase shift processing on the radio frequency signal. Finally, nine output lines are formed. The nine output lines are electrically connected to output interfaces 240. The plurality of output interfaces 240 are connected to a plurality of radiating elements of an antenna array. Each output interface 240 feeds, into a radiating element connected to the output interface 240, a radio frequency signal processed by a corresponding feeding circuit, so that the radiating element radiates an electromagnetic beam outward.

In some other embodiments, the phase shift feeding apparatus may further include another functional module, which may also be referred to as another functional network, for example, a phase compensation module. An applicable functional module is arranged at an appropriate position, to implement miniaturization of the phase shift feeding apparatus.

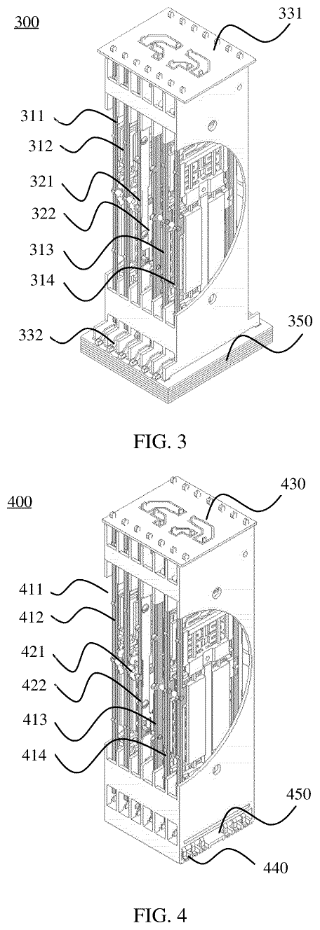

FIG. 3 is a diagram of a structure of another phase shift feeding apparatus. FIG. 3 shows a phase shift feeding apparatus 300 in a 1-to-5 parallel feeding form. As shown in FIG. 3, the phase shift feeding apparatus 300 includes a plurality of phase shift modules, for example, a phase shift module 311, a phase shift module 312, a phase shift module 313, and a phase shift module 314, and includes a plurality of power division modules, for example, a power division module 321 and a power division module 322. As shown in FIG. 3. The plurality of phase shift modules and power division modules are stacked in a sequence of the phase shift module 311, the phase shift module 312, the power division module 321, the power division module 322, the phase shift module 313, and the phase shift module 314. In other words, the plurality of power division modules are disposed adjacent to each other and are disposed at an inner layer of a stacked structure, and the plurality of phase shift modules are disposed at an outer layer of the stacked structure.

Certainly, the foregoing descriptions are merely a stacking example of the plurality of phase shift modules and power division modules, and there may be another manner of stacked distribution. For example, the plurality of phase shift modules are stacked adjacently, and the plurality of power division modules are stacked adjacently; or the plurality of phase shift modules are stacked adjacently and are located at an inner layer of a stacked structure, and the plurality of power division modules are located at an outer layer of the stacked structure.

Referring back to FIG. 3, the phase shift feeding apparatus 300 further includes a transfer module 331, transfer interfaces 332, and a phase compensation module 350. The transfer module 331 is disposed at one end of the stacked structure. The transfer module 331 electrically connects the plurality of phase shift modules and power division modules, to form a plurality of feeding circuits. The transfer module 331 is disposed on a same plane, for ease of integration.

The phase compensation module 350 is disposed at an end that is of the stacked structure and that is opposite to the transfer module 331, and a shape of the phase compensation module 350 is adapted to a shape of an end surface of the stacked structure.

The phase compensation module may include a housing and a phase compensation circuit. The phase compensation circuit is accommodated in an accommodating cavity formed by the housing. A shape of the housing of the phase compensation circuit is adapted to a shape of an end surface of a stacked structure in which the phase compensation circuit is disposed. For example, if the end surface of the stacked structure is rectangular, the shape of the housing of the phase compensation circuit is of a rectangular plate structure.

A type of the phase compensation module is not specifically limited in the phase shift feeding apparatus provided in this embodiment of this application. For example, the phase compensation module may be a phase compensation module of a type such as feedforward compensation, feedback compensation, or series compensation.

Optionally, the phase compensation circuit of the phase compensation module may be of a multilayer PCB board structure (referring to FIG. 3), or may be in a strip line form.

FIG. 4 is a diagram of a structure of a phase shift feeding apparatus in which a phase compensation circuit of a phase compensation module is in a strip line form. As shown in FIG. 4, a phase shift feeding apparatus 400 includes a plurality of phase shift modules, for example, a phase shift module 411, a phase shift module 412, a phase shift module 413, and a phase shift module 414, a plurality of power division modules, for example, a power division module 421 and a power division module 422, a transfer module 430, a plurality of output interfaces 440, and a phase compensation module 450.

The plurality of phase shift modules and power division modules are stacked in a sequence of the phase shift module 411, the phase shift module 412, the power division module 421, the power division module 422, the phase shift module 413, and the phase shift module 414, to form a stacked structure. The transfer module 430 is disposed at an end part of one end that is of the stacked structure and that extends in a length direction, and is configured to electrically connect the plurality of phase shift modules and power division modules, to form a plurality of feeding circuits. The phase compensation module 450 is disposed at the other end that is of the stacked structure and that is opposite to the transfer module, and is configured to adjust signals fed by the plurality of feeding circuits. The output interfaces 440 are stacked with the phase compensation module 450, and are electrically connected to output lines of the phase shift feeding modules. The plurality of output interfaces 440 are connected to a plurality of radiating elements of an antenna array. Each output interface 440 feeds, into a radiating element connected to the output interface 440, a radio frequency signal processed by a corresponding feeding circuit, so that the radiating element radiates an electromagnetic beam outward.

An embodiment of this application further provides an antenna, including the foregoing phase shift feeding apparatus and a plurality of radiating elements. The phase shift feeding apparatus feeds a processed radio frequency signal into the plurality of radiating elements, so that the plurality of radiating elements radiate electromagnetic beams outward, to implement miniaturization of the antenna.

When the antenna includes a passive antenna assembly, an active antenna assembly, and an electromagnetic transparent antenna assembly, the passive antenna assembly includes the phase shift feeding apparatus provided in embodiments of this application, so that impact caused by the active antenna assembly and the electromagnetic transparent antenna assembly can be reduced.

An embodiment of this application further provides a base station, including the antenna provided in embodiments of this application, to implement miniaturization of the base station.

An embodiment of this application further provides a communication system, including the base station provided in embodiments of this application, to implement miniaturization of the communication system.

Certainly, the phase shift feeding apparatus provided in embodiments of this application may be further used in another device that needs a miniaturized phase shift feeding apparatus, for example, a phased array radar device or a satellite communication device.

In description of this specification, specific features, structures, materials, or characteristics may be combined in an appropriate manner in any one or more embodiments or examples.

Finally, it should be noted that, the foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

1. A feeding apparatus, comprising:
a plurality of functional modules, wherein each functional module is configured to process a radio frequency signal; and
the plurality of functional modules are stacked in a same direction or stacked in different directions.

2. The apparatus according to claim 1, wherein the plurality of functional modules comprise:
N phase shift modules, wherein each phase shift module is configured to perform phase shift processing on an input radio frequency signal, and N is a positive integer greater than or equal to 2;
M power division modules, wherein each power division module is configured to perform power allocation processing on the input radio frequency signal, and M is a positive integer greater than or equal to 1; and
a transfer module, configured to electrically connect the phase shift module and the power division module, to form a feeding circuit, wherein
the N phase shift modules and the M power division modules are stacked in a same direction or stacked in different directions.

3. The apparatus according to claim 2, wherein the N phase shift modules and the M power division modules are alternately stacked in a same direction.

4. The apparatus according to claim 3, wherein the transfer module comprises a first transfer submodule and a second transfer submodule, and the first transfer submodule and the second transfer submodule are respectively disposed at two opposite ends of a first stacked structure formed by the N phase shift modules and the M power division modules.

5. The apparatus according to claim 2, wherein the N phase shift modules are stacked to form a second stacked structure, and outer wall surfaces of the M power division modules in an extension direction are in contact with end parts of the second stacked structure.

6. The apparatus according to claim 2, wherein the N phase shift modules and the M power division modules are stacked in a same direction to form a third stacked structure, and the M power division modules are stacked adjacently.

7. The apparatus according to claim 6, wherein the M power division modules are located at an inner layer of the third stacked structure, and the N phase shift modules are located at an outer layer of the third stacked structure.

8. The apparatus according to claim 6, further comprising a phase compensation module, wherein
the phase compensation module and the transfer module are respectively disposed at two opposite ends of the third stacked structure.

9. The apparatus according to claim 1, further comprising a plurality of output interfaces, wherein each output interface is configured to output a radio frequency signal processed by the feeding apparatus; and
the plurality of output interfaces are disposed on a same plane or disposed on different planes.

10. The apparatus according to claim 1, wherein each functional module comprises a circuit structure and a cavity, and the circuit structure is accommodated in the cavity.

11. The apparatus according to claim 1, further comprising a frame structure, wherein
the frame structure is configured to support and position the plurality of functional modules, so that the plurality of functional modules form a structure stacked in a same direction or stacked in different directions.

12. The apparatus according to claim 1, wherein the plurality of functional modules are detachably connected.

13. The apparatus according to claim 1, wherein the feeding apparatus is integrally formed.

14. An antenna, comprising:
a feeding apparatus and a plurality of radiating elements, wherein the feeding apparatus feeds a processed radio frequency signal into the plurality of radiating elements, so that the plurality of radiating elements radiate electromagnetic beams outward;
wherein the feeding apparatus, comprises:
a plurality of functional modules, wherein each functional module is configured to process a radio frequency signal; and
the plurality of functional modules are stacked in a same direction or stacked in different directions.

15. The apparatus according to claim 14, wherein the plurality of functional modules comprise:
N phase shift modules, wherein each phase shift module is configured to perform phase shift processing on an input radio frequency signal, and N is a positive integer greater than or equal to 2;
M power division modules, wherein each power division module is configured to perform power allocation processing on the input radio frequency signal, and M is a positive integer greater than or equal to 1; and
a transfer module, configured to electrically connect the phase shift module and the power division module, to form a feeding circuit, wherein
the N phase shift modules and the M power division modules are stacked in a same direction or stacked in different directions.

16. The apparatus according to claim 15, wherein the N phase shift modules and the M power division modules are alternately stacked in a same direction.

17. The apparatus according to claim 16, wherein the transfer module comprises a first transfer submodule and a second transfer submodule, and the first transfer submodule and the second transfer submodule are respectively disposed at two opposite ends of a first stacked structure formed by the N phase shift modules and the M power division modules.

18. The apparatus according to claim 15, wherein the N phase shift modules are stacked to form a second stacked structure, and outer wall surfaces of the M power division modules in an extension direction are in contact with end parts of the second stacked structure.

19. The apparatus according to claim 15, wherein the N phase shift modules and the M power division modules are stacked in a same direction to form a third stacked structure, and the M power division modules are stacked adjacently.

20. The apparatus according to claim 19, wherein the M power division modules are located at an inner layer of the third stacked structure, and the N phase shift modules are located at an outer layer of the third stacked structure.
